(19) United States
(12) Patent Application Publication
(10) Pub. No.: US 2011/0113410 A1
(43) Pub. Date: May 12, 2011

(54) Apparatus and Method for Simplified Microparallel Computation

(76) Inventor: Larry W. Loen, Maricopa, AZ (US)

(21) Appl. No.: 12/941,000

(22) Filed: Jan. 20, 2011

Related U.S. Application Data
(60) Provisional application No. 61/258,586, filed on Nov. 5, 2009.

(51) Int. Cl. G06F 9/45

(52) U.S. Cl. 717/149

(57) ABSTRACT

The embodiments provide schemes for micro parallelization. That is, they involve methods of executing segments of code that might be executed in parallel but have typically been executed serially because of the lack of a suitable mechanism

### CROSS REFERENCE TO RELATED APPLICATIONS

This application claims the benefit of U.S. Provisional Application No. 61/258,586 filed on Nov. 5, 2009. Additionally, the entire referenced provisional application is incorporated herein by reference.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

The embodiments disclosed relate to the field of computer architecture and computer compilation. Specifically, they relate to methods to improve parallel computation.

(2) Description of Other Art

Modern computing has reached a crossroads. Previously, in what one could regard as a corollary to Moore's Law, computer clock speeds could be expected to increase (even double in frequency) on a regular basis right along with the rest of Moore's Law. That is to say, as circuit density increased, so would the clock speed in a roughly proportional manner. This has now apparently halted. Clock speeds can now be expected to increase slowly if at all.

However, Moore's Law proper continues unabated. It has long been understood that the increasing circuit density could be used to implement an increased number of processors (now often called cores) in the same space. This is now being done in lieu of increasing the clock speed. The expectation is that programmers will break up existing programs so that they can cooperatively use more cores and thus keep increasing performance.

For many applications, this expectation can be largely or wholly met. The classical example would be web serving. Here, in many cases, as long as the hard disks providing data do not compete much with each other, an increased workload can be accommodated simply by having more “jobs” (here, a software defined unit of separately dispatchable work) available to receive new web serving requests as they accumulate. That is, as file serving requests come in from the general internet, the operating system simply arranges to hand each new request off to a waiting job; the job can then be loaded on an available processor and work goes on in parallel, servicing a fairly arbitrary number of requests concurrently. Since reading from disk is commonplace in this application and since (in some cases) contention for the disks is low, it is often easy to use all the available cores in such a scheme.

However, there is a problem even here. In such a case, the individual web page is not served any faster. One can serve more web pages with the next generation of computer, but each web page takes just as long or nearly so as it did with the last generation of processor. Thus, the increase in processor (core) count increases throughput (total work performed) but not response time (the time to service a particular web page). In the era of rising clock speeds, one tended to see both improve.

And there are applications that resist (some would say “actively resist”) parallelization. Thus, it may take substantial effort for some classes of application to increase performance. For instance, many “batch” processes were not written with multiple cores in mind. They may, for instance, repeatedly reference or increment common data or common records (e.g. summary data of various sorts are common in these applications, such as “total weekly sales”). Because all jobs (in a multi-job scheme) would need to access these fields, sooner or later, this may make it anywhere from difficult to impossible to break the work up into multiple jobs in an effective way.

Moreover, these schemes favor, as a practical matter, coarse grained sharing where the size of the sharing units involve large numbers of instructions.

All of this means that there is incentive for schemes that increase parallelization of programs, particularly any which improve response time as well as throughput.

What is lacking in the existing art are schemes that favor smaller sequences of instructions, particularly those that are uncovered by the compiler during its optimization phases that typically examine smaller segments of code.

### BRIEF SUMMARY OF THE INVENTION

The embodiments provide schemes for micro parallelization. That is, they involve methods of executing segments of code that might be executed in parallel but have typically been executed serially because of the lack of a suitable mechanism.

### BRIEF DESCRIPTION OF THE SEVERAL VIEWS OF THE DRAWING(S)

FIG. 1 shows a description of a typical computer system on which various embodiments are performed.

FIG. 2 shows details of a principal variation regarding use of computer memory cache.

FIG. 3 illustrates added registers contained in some embodiments.

FIG. 4 illustrates an embodiment showing the added registers of FIG. 3 organized for four execution units.

FIG. 5 illustrates an example input program transformable according to at least one embodiment.

FIG. 6 illustrates a conceptual change to FIG. 5 that illustrates an instance of the original program of FIG. 5 reorganized for parallel execution.

FIGS. 7A-7C collectively illustrate how an instance of the example program of FIG. 5 is re-written by at least one embodiment.

### DETAILED DESCRIPTION OF THE INVENTION

In the following detailed description of embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

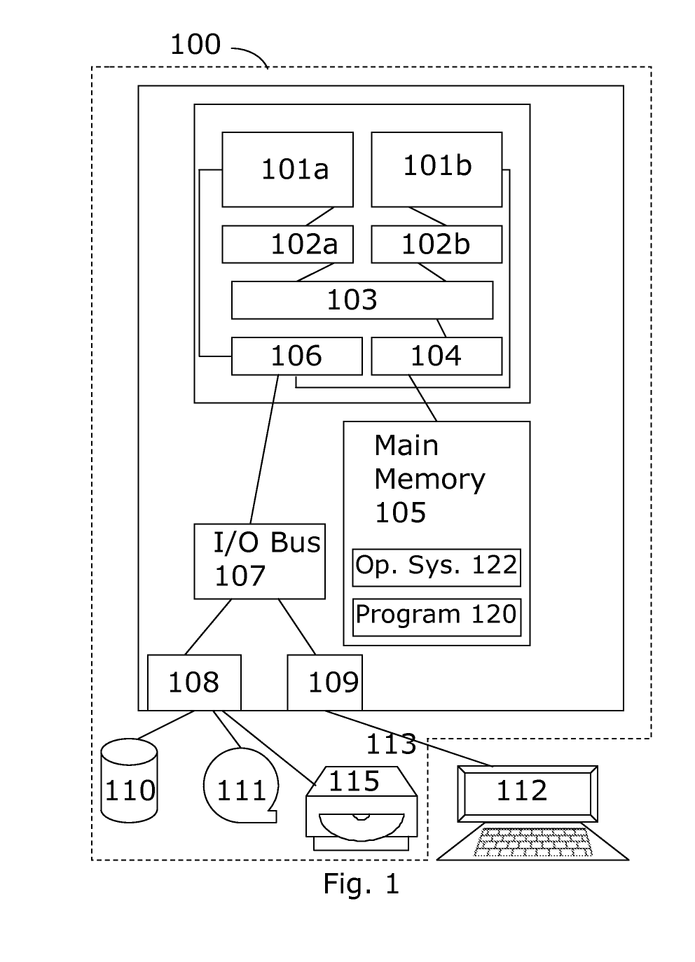

FIG. 1 shows one embodiment of the present invention having a computer system 100. In computer system 100 a plurality of execution units (collectively, 101; shown here as two, 101a, 101b) each execute computer instructions fetched from main memory 105 into suitable caches, here shown as L3 cache 104, L2 cache 103 and individual L1 (collectively, 102; shown here as two such, 102a and 102b). Each cache is operatively connected to the other, and to the processors 101, as shown by the corresponding unnumbered lines as is known in the art. In some embodiments (e.g. PowerPC) the L1 cache 102 may each be further split into a separate instruction and data cache or they may be combined into a single cache as the embodiment prefers (separate “instruction” and “data” caches are not shown). In some embodiments, the L3 and L2 cache may be omitted, in which case the L1 caches are connected (via sharing techniques known in the art) directly to main memory 105. If L3 alone is omitted, then L2 is directly connected to main memory 105. In the embodiment shown, L2 is shown as the location where sharing takes place between the two L1 caches 102a and 102b. All of these variations are well-known in the art. Further variations with multiple L2 caches 103 and more execution units 102 are possible, in which case the memory sharing takes place between the various L2 caches 103 and L3 cache 104. There could be embodiments without any cache as well.

In FIG. 1, each execution unit 101 is operatively connected to a particular and individual L1 cache 102. Further, the execution unit(s) 101 not only fetch instructions (from, for instance, program 120 or operating system 122), but also data from main memory 105. These programs whether program 120 or operating system 122 process the data, according to the defined instructions from program 120 and operating system 122, such that data is moved between the caches, main memory 105, and also various registers and processing units (not shown) contained within the execution units 101. Program 120 may be an application program or other suitable program. Instructions from the program 120 and operating system 122, as executed by execution units 101, further manipulating I/O Bus Interface 106, I/O Bus 107 and interface cards 108 and 109. These cards, whether custom created or using industry standard techniques, will in turn, communicate to peripheral devices. Typical devices are magnetic disk 110, tape drive 111, CD-ROM drive 115 and one or more terminals 112 connected by typical terminal cabling mechanism 113. Typically, a different interface is used to connect devices such as terminals as compared to CD-ROM, tape, and magnetic disk. None of this is critical to the embodiments shown; any means of connection to the various devices and computer system 100 work. Moreover, future devices, such as flash memory, might be used in place of, or in addition to, the devices 111 and 110. A network interface (not shown) could connect the computer system 100 to other computer systems, either locally or over the internet. Terminals 112 might be located on the other end of such a connection or be emulated in various ways, providing the equivalent of terminal access for FIG. 1 in lieu of or in addition to the connections shown. However done, terminals 112 provide an opportunity for humans to interact with the system, particularly to cause programs 120 to be loaded, and to view output or cause output to be sent to a printer (not shown). A typical program might be loaded from a magnetic disk 110, a tape media mounted in tape drive 111, or a non-writable CD-ROM media contained in CD-ROM drive 115. The operating system 122 typically provides mechanisms for running a plurality of programs 120 such that there can be multiple execution entities (not shown, but could include UNIX processes, AS/400 jobs, or other similar entities) each executing their own program 120 (whether the identical program or one of a plurality of available programs) all sharing main memory 105, the various execution units, devices, and the caches in such a manner as to prevent various programs 120 from seeing each others' view of main storage except via explicit planning.

Further, it is expected that in the environment of FIG. 1, the execution units typically use “virtual storage” and that the translation from a virtual storage address, as supplied by an execution unit, to a physical main memory location is handled in the execution unit in cooperation with the L1 cache (the operating system 122 having arranged for the mapping to take place correctly). The remaining caches and main memory 105, then, are typically addressed using the underlying physical address (sometimes called a “real” address in the art). Thus, a program resides in main storage and is typically accessed via virtual address. To simplify this, a reference to simply “loading a program into memory” will encompass both the residence in main storage and the various means used, if present, to represent the program using virtual storage techniques.

“Execution unit” is a term of art used in this disclosure to cover a variety of entities in today's computer systems. In earlier embodiments, these were simply called CPUs or processors and each individually contained the entire available, defined machine state for a CPU or processor as defined by a given processor architecture. However, over the years, refinements have taken place. IBM via its AS/400 introduced “hardware multi-tasking” (today it would be called “hardware multi-threading”) and Intel introduced “hyper-threading.” In these embodiments, a certain amount of reduction might take place between particular sets of execution units. That is to say, some may implement only a partial processor. In a typical embodiment, some of the special registers used by the operating system 122 may, particularly, be omitted. In others, certain execution facilities could be shared between execution units. This was originally motivated to permit execution units to share execution resources (such as the ALU) when one of the two units was stalled on a long running operation such as a cache miss. Depending on the amount of hardware investment, the two execution units in a “hyper-threaded” style design vary in the amount of available concurrency. On the whole, the more complete the processor state, the more the concurrency. Such details do not generally concern this disclosure. What is assumed, in the embodiment of FIG. 1, is that each execution unit, whether a full-blown processor, or some sort of hyper-thread, is capable and typically expects to run disjoint operating system processes (e.g. a process corresponding to a UNIX process) such that they do not share main storage without effort. The hardware does not assume, and in some cases actively prevents, the two from sharing resources without appropriate preparation. In the System i Single Level Storage architecture, this separation is also assumed, but accomplished in a different way. However, the distinction is the same in practice, especially at higher levels of security where the mechanisms are more akin.

Note that the various peripherals of computer system 100 are show as enclosed or not enclosed in the dashed lines which indicates the physical boundaries of computer system 100. This is typical and not required; in some embodiments, some or all of the peripherals might reside in some external package and not be contained in the physical boundaries of computer system 100. In other embodiments, all peripherals, perhaps including the terminal 112, are enclosed and advantageously connected to the interface cards 108 and 109 of computer system 100 (as was the System/38 produced by IBM).

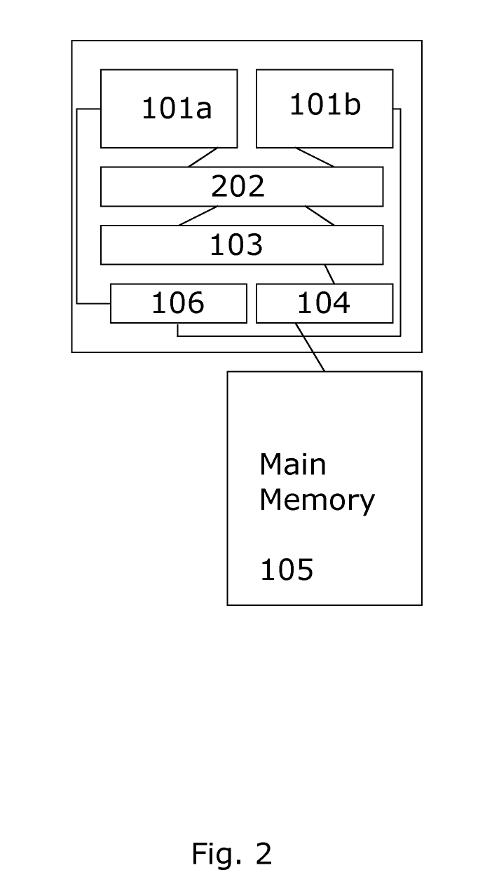

Meanwhile, FIG. 2 shows an embodiment where the separation between processes may be somewhat relaxed. FIG. 2 describes changes to the cache configuration of computer system 100. Other elements of computer system 100 are omitted for clarity.

A process (e.g. a UNIX process, an AS/400 job) might include one or more threads. A thread, as the operating system defines it, is not an execution unit, but a software defined execution entity. It is a special subset of a process. In particular, the several threads sharing the same process do share the same view of virtual storage. That is, they share the paging tables as defined by their common process. The hardware may take note of this in the embodiment of FIG. 1, such as to improve performance (key registers relating to paging will have identical contents), but in general the hardware is organized to enforce separation between threads whose underlying process is different as is often the case. In FIG. 2, by contrast, L1 cache is shared (L1 cache 202, other reference numbers as in FIG. 1). Now, some embodiments with L1 cache 202 may still enforce the distinction between threads of different processes, but in FIG. 2, one embodiment will describe the case where it is known and expected that the two threads do, in fact, share a common process (a common definition of virtual storage) and this fact is exploited. As defined here, all processes have at least one thread.

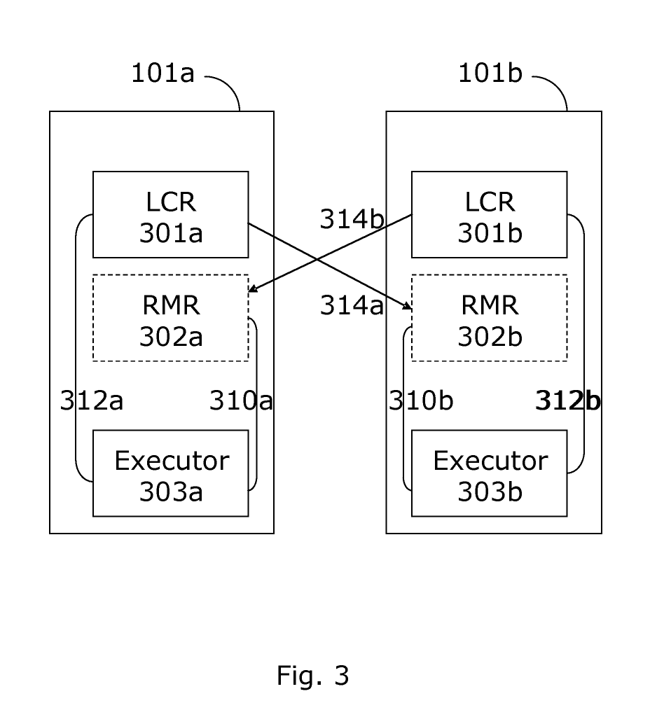

FIG. 3 shows added registers LCR (Local Register, collectively or generically 301; with two such, 301a in 101a and 301b in 102b shown) and RMR (Remote Register, collectively or generically 302, with 302a in 101a and 302b in 102b shown). These registers exist between two cooperating execution units 101. The term “executor” (e.g. “executor,” collectively or generically 303; shown as 303a for 101a and 303b for 101b) is meant to imply any suitable part of any particular execution unit 101. It might be the ALU, it might be a subset of what PowerPC calls Special Purpose Registers or some other entity. All that is needed is that any “executor” 303 connects the added registers RMR 302 and LCR 301 to the rest of the corresponding execution unit 101 by suitable means. The RMR 302 is a particular “remote” register expected to reside in another cooperating execution unit. Since only a pair of such units (101a and 101b) are shown in FIG. 3, there is a single LCR and RMR shown in each execution unit. Note that the RMR may be implemented in any suitable fashion, as indicated by the dashed lines. It may be its own full blown register, a simple buffer (latched or not) or even nothing at all, in which case the corresponding LCR in the other processor flows directly into the corresponding “executor” 303 of “this” unit. Thus, the contents of the LCR 301a will flow over some suitable signal carrier 314a to whatever represents RMR 302b and thence via suitable signal carrier 310b to “executor” 303b. In the embodiments shown, signal carriers 314a and 310b are expected to be uni-directional (“read only”) interfaces. Thus, RMRs are not modified locally, but only read from their remote register. The LCR 301b, by contrast, is certainly written from “executor” 303b through suitable signal carrier 312b. In some embodiments, it could also be read by “executor” 303b over 312b from LCR 301b. In both cases, the data may of course be obtained from or sent to farther resources of the processor beyond the executor proper. Similarly, the contents of the LCR 301b will flow over some suitable signal carrier 314b to whatever represents RMR 302a and thence via suitable signal carrier 310a to “executor” 303a. Similarly, the LCR 301a, is certainly written from “executor” 303a through suitable signal carrier 312a. Embodiments need only ensure that changes to LCRs propagate atomically.

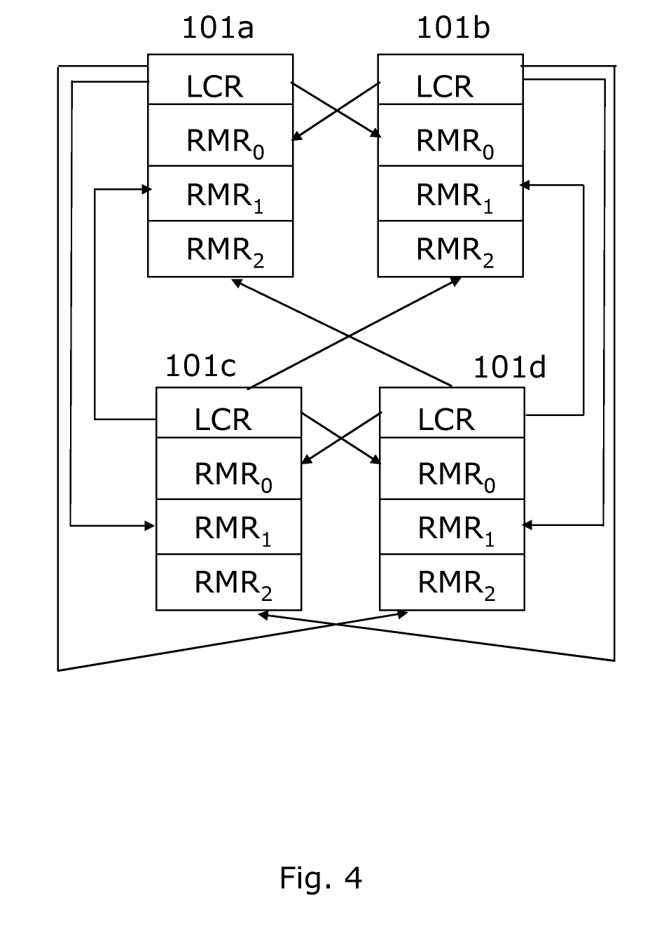

FIG. 4 expands on FIG. 3 to show relevant aspects of FIG. 3 where computer system 100 has four execution units. While FIG. 1 had no 101c or 101d, a four execution unit version would have had them and so those execution units are introduced in FIG. 4 in abbreviated form along with their designators. Note how the connections between the various LCRs and the corresponding partner execution unit connect in this embodiment. Essentially, each unit is paired with the other in terms of corresponding RMR numbers. Thus, 101a feeds its LCR to 101c as the RMR₁ of 101c; similarly 101c feeds its LCR to 101a as the RMR₁ of 101a.

The schemes of FIGS. 3 and 4 will work in the environment of either FIG. 1 or FIG. 2. The schemes of FIGS. 3 and 4 will also work in other cache configurations known in the art, including no cache at all. Moreover, there is no requirement that the cooperating execution units 101 be of any particular form (e.g. full processors, hyperthreads, etc.). All that is needful is that they can access the other's registers as described with reasonable efficiency (e.g. comparable access and modification costs compared to registers such as a branch register or a condition code register within the architecture). That may happen to work best on more hyper-threaded implementations, but that is an implementation detail and not a requirement.

The term “process” is used in a more or less classic UNIX sense (but not limited to UNIX operating systems). This means that there is an execution entity, typically existing in storage, which keeps track of the entire execution state of at least one program that is given initial control, including copies of all relevant state registers, particularly including general purpose registers, the instruction address register, and registers that define the virtual address translation to the hardware. When a process is dispatched for execution, all those registers are loaded into physical registers on a selected processor, and execution commences where the instruction address register indicates. The process thus consists of memory locations that keep track of the current state of both the registers undergoing change by the program and also the virtual memory mapping. A “process” may have one or more threads of execution. Whether the first execution entity within a process is called a thread is a matter of local definition (this disclosure will do so). Other execution entities form optional additional threads of execution. What distinguishes threads from processes is a reduction in state and, as defined here, a formal association with a particular process. That is to say, a thread is any execution entity that shares the same virtual address translation as the “first” execution entity (thread) of the process. Its state is kept in memory also when not executing, but it need only replicate a subset of the process' state (particularly, the virtual memory mapping is process-wide and the same virtual address translation registers are process-wide). Put another way, all threads in a process share the same virtual storage definition.

Note that there are other definitions of “process” and “thread” described herein, but they are qualified by appropriate terms such as “hardware” (e.g. “hardware thread”) to distinguish them from the usage here.

Common Embodiment Concepts

As terms of art for this disclosure, there are two types of binaries generated by the compiler from a single input program. The original program can be viewed as comprising one or more code groups, divided in whatever manner the compiler finds useful. When one or more code groups of the original input program are deemed profitable for parallel execution, this disclosure's methods apply. The code groups that are profitable for parallel execution will be further divided into code segments that individually execute in parallel on at least two execution units. One segment will always execute on a first execution unit, any added execution units will be dependent execution units associated with dependent threads. The first and dependent segments will require other code for communication to be described. Together, the first and dependent segments, with communications code, accomplish the function provided by the original input code group. Typically, there are code groups that are not capable of being profitably divided for parallel execution and these execute in the first execution unit using ordinary execution schemes. Thus, the two types of binaries are the dependent binaries (made up the dependent segments of code groups that can be further divided into code segments plus the communications required by the dependent code) and the first binary which includes each first code segment, communication code required by the first code segment, and code groups that are not capable of being profitably divided for parallel execution.

In this set of related embodiments, the compiler searches for “long enough” sequences of code to be profitable in view of a parallel execution scheme. The program is loaded normally and receives control at a particular first code group which begins executing on a first execution unit as a first thread. It signals the operating system it wishes parallel execution and associates the second type of binary, called a dependent binary, with at least one additional thread executing on at least one additional execution unit (a dependent thread on a dependent execution unit). The compiler does not have to understand these “threading” mechanism(s) in detail. It need only know that the memory is shared such that any memory it allocates for code and data will be known at the same address for all code groups and all code segments, and, for data, be read/write or (if the compiler itself desires it) read only. When the operating system associates a particular dependent binary with a particular execution unit, it ideally selects an execution unit which minimizes the access costs of the shared cache lines (or, for FIG. 3 or FIG. 4 embodiments, minimizing the register access costs) in relation to the first execution unit. The compiler that produced the binaries could configure the program (or generate code so as to inform the loader at execution time) as to what the preferred assignments might be. In some embodiments, the programmer might instead assist the compiler by providing such information in code or configuration data.

In a conventional processor, the presumption generally made is that shared cache lines are comparatively rare, that threading is coarse-grained, and that therefore, typically, the code streams (and data references) are typically disjoint. This, the hardware and operating system typically operate such that an “adjacent” execution entities can be a coarse grained thread or a different process altogether (where sharing storage becomes complex). In both cases, while shared storage is allowed (that is, between threads or even between processes), it is treated as an exceptional event and this exceptional nature is typically built into the hardware. Even so, there can be performance improvements by having threads and/or processes that share memory in some embodiments where the threads are physically adjacent in some way and the operating system will typically wish to account for this when it is able. This may include possibly providing “hint” system calls so the operating system can be alerted to any sharing relationship as defined here. Alternatively, as far as the code load goes, all the code can be loaded at one time, conventionally, and threads could even be ordinary threads already provided (e.g. pthreads), but perhaps with a bit more understanding by the compiler and the operating system than usual of the relationships between threads and the hardware configuration to exploit the relationship.

Those skilled in the art will appreciate that extending a two execution unit embodiment to more than two parallel execution units is straightforward. The dependent binary simply has more code segments in it, suitably renamed, and the added execution units are initiated in the dependent binary using the proper code segment with the only difference being that they are instructed (to the degree required) that they are the third, fourth, etc. execution unit either with some sort of configuration scheme or constants in their executable code. Thus, the second and subsequent dependent code segments can be identical or different as the embodiment requires.

Shared Cache Embodiments

In one particular embodiment, a conventional shared static storage area is declared and known to binaries generated by the compiler from a single input program. The first binary executes code groups not profitable for parallel execution in a conventional manner. Meanwhile, library code associated with a dependent thread, executing independently from the first in at least one dependent execution unit with its own dependent thread (the threads thus having a shared understanding of memory), polls the shared static storage area using “safe” instructions such that changes made by one execution unit are properly propagated and visible to the other. The easiest and most universal way is through memory. “Safe” will mean special memory access schemes of a given architecture, which means they are fairly slow as changes to memory state typically propagate fairly far to be “safe” or at least be available for correct movement between caches. Suitable instructions exist to ensure this in modern architectures (e.g. “Test and Set”, “Compare and Swap” in the IBM 370 and later architectures, “Load and Reserve” and “Store Conditional” in Power PC), but performance may be an issue. The required time to ensure propagation of values between processors may be in the tens if not hundreds of cycles (another good reason to load the dependent program on an “adjacent” execution unit so as to limit this very overhead to a lesser value). One embodiment would be for the first execution unit to have an assigned memory location for each dependent execution unit that the first execution unit alters for benefit of that particular dependent execution unit and each dependent execution unit having an assigned memory location that it alters for the benefit of the first execution unit. Another enhancement to such embodiments is to have each memory location on its own cache line.

The dependent code segment, while polling the shared memory, will look for one of two values. The first value, perhaps zero or some other suitable convention, represents a value that is known not to be a proper program address. Once the dependent code segment sees a proper program address, which represents one of the dependent program's segments (that is, its part of a code group profitable for parallel execution) it arranges to branch to that address. The code at that address, knowing it is a dependent segment will, in turn, perform its segment processing proper and then conclude this portion of the processing by safely setting a shared storage area back to an invalid program address. In some embodiments, “not a valid address” could be initially set as part of the loading of code, thus achieving a proper initial value for the dependent segment's static area; others could achieve this via another scheme. The setting and reading of the cache areas thus represents communication between the first thread and the dependent threads.

While the dependent thread polls the memory area, awaiting a suitable address, the first thread executes normally; particularly, executing any code groups not profitable for parallel execution. Once it reaches an area suitable for parallel execution (determined at compile time by the program's compiler or also by an assembler coder), it sets the shared area to a known address which is the segment representing the dependent thread's portion of the entire code group. The first program executing on the first processor then continues with its share of the parallel execution (that is, its own segment, proper).

Note that more than two execution units and more than two segments are possible. The first would always contain the non-profitable code groups and initiate communications with the dependent execution units. These dependent segments, with the first segment, and the communication code, produce results consistent with conventional compilation. Whether the same code could be used for each dependent segment on each dependent execution unit or whether the code would vary somewhat for each execution unit would be an implementation detail. The compiler will know how to configure the dependent segments and the first segment.

When the first segment finishes the parallel execution, it knows that the dependent segments on the remaining execution units were executing their portion asynchronously. It therefore polls a shared memory location (it can be the same one a given dependent segment polled or a different one as long as the particular segments agree on which to use) to see when each dependent segment on each dependent execution unit completed its work. If any dependent segment suffers an error, then the first segment will have to be prepared to wait for a suitable timeout (ordinary delays such as paging by the dependent segment would be accounted for) or it might in some embodiments see some other conventional value as it polls the shared area that indicates “not a program address” but additionally “not a successful execution.” Since there will be a limited number of locations where code segments commence, many conventions and values are possible because many values are available, especially as many architectures have reserved address ranges which would all be available for such conventions. Alternatively, the compiler and loader could arrange to skip a known address range. Note that if a full cache line is shared, something more straightforward can be done than sharing a single value of the width of the program address register, but the scheme here works even if the cache line is small. This could allow a fairly large state to be encoded even in a 32 bit register and certainly a 64 bit register. Thus, states including “busy,” “available,” “terminate” and the like could be encoded, including potentially by the operating system 122 or error handling within program 120.

In an embodiment using a full cache line instead of the small state just described, each segment may have its own “write only” cache line upon which it safely writes a complex state and that any other could safely interrogate (“safely” again means using mechanisms provided to ensure correct values in view of modern caching and for other reasons). Thus, states like “busy,” “available,” “unused,” “terminate,” “not executing,” “timed out,” and “error” could be encoded straightforwardly and separately from the instruction address transmission. It could also include items elsewhere in the cache line such as a current stack address so that when the first parallel thread instructs dependent threads to commence execution, each dependent thread can do so with a correct and usable stack register and so allow fast and convenient access to storage shared between the segments.

To achieve the performance goals of a typical embodiment, the operating system preferably cooperates with this scheme in ways beyond the previous discussion. For instance, if the operating system implements the commonplace function of a time slice, it must ensure that these segments on their several execution units are sufficiently synchronized such that both can be dispatched together reasonably close in time in most instances. This would enable other such collections of segments from other “jobs” or “processes”, if available, to execute, but at the least, it aids in the timeout calculation just referenced. Secondly, if the “job” or “process” as a whole is to be preempted, or terminated, it must account for any remaining segments on other execution units. To some extent, this may happen simply by the virtue of both being implemented as conventional threads from a common parent process (in some embodiments, despite what was just said, that may be sufficient and no operating system assist would be required). In brief, the operating system preferably keeps track of the relationships between threads and their underlying execution units (most easily be done by a suitable parameter given when the dependent binary is loaded and/or the several remaining threads are launched) and account for the cooperating set of threads and their underlying execution units in many operations. It can permit them to execute separately from time to time (given the asynchronous nature, this is, to a degree, unavoidable), but the general philosophy and performance enhancement will come when all are executing together since they poll each other with regularity and the operating system will typically not know when this happens. In fact, the operating system will typically not be informed when they are checking each other, since the profit of the present invention is not necessarily based on large numbers of instructions—supervisor calls to inform the operating system could easily eat up the profits from this disclosure in a modern processor both because of the cost of the interrupt itself but also because of the number of instructions needed to minimally process a supervisor call.

Shared L1 Cache Embodiment

The previous embodiment can be enhanced according to FIG. 2. In this embodiment, the execution units 101a and 101b can be configured to know they are execution units executing the aforementioned first segment and aforementioned dependent segment. In this scenario, given their common view of virtual storage, and given the sharing of L1, the profits at a given opportunity are likely to be higher and the available places to do parallel work could easily increase because shorter sequences qualify for inclusion thanks to fewer cycles lost moving cache lines from one L1 to another. (For the moment, only two execution units will be discussed, but those skilled in the art will readily see that, as with the previous embodiment, this generalizes to more execution units than two).

How would the embodiment of FIG. 2 be achieved? One would be to require the adjacent execution units to share a view of main storage. This could be as simple as sharing the relevant registers involved in virtual storage translation between execution units 101a and 101b. One might protest that if a given program was not compiled with a dependent program available at all, one execution unit would be wasted. That is true, but given the difficulties of parallel programming, in some embodiments, that might be an acceptable trade-off.

In a different embodiment that could achieve FIG. 2, and provided the appropriate distinctions could be managed, the L1 cache virtual translation process could accommodate both 101a and 101b and contention between them. All that would be needful is that the translation as remembered by the unified L1 cache used a full virtual address (containing some suitable indication of the underlying processes, for instance) so as to distinguish the regular case (where, in general, the processes of two executing threads are not the same) and this case (where they share the underlying process or, equivalently, the same view of virtual storage from the same process). The profit from such an embodiment would depend on what amount of added state, if any, was required to permit the sharing with sufficient efficiency, and whether the case of a conventional program (with no notion of first and dependent segments as described here) was reduced in performance, if indeed there is any such reduction. It might even be possible to implement this latter alternative with a scheme more like FIG. 1 than FIG. 2. In this revised embodiment, not shown in a figure, the two L1 caches would be favorably coupled, and transmit cache lines quickly from one to the other in the case of a shared view of main storage, but would otherwise behave as conventional, separate caches. This would permit the two execution units to continue to execute threads from separate processes and so have little or no penalty when conventional programs are in use.

Shared Registers Embodiment

The concepts behind this embodiment are similar to the shared cache embodiments just described, except that some additional hardware is implemented to increase the profitability of the scheme. As already noted, the execution units in the shared cache embodiment will communicate via shared memory using “safe” instructions so as to account for a given architecture's concept of memory consistency (“weak” versus “strong”, etc.). However, in some embodiments, “safe” instructions are relatively slow. This embodiment would be particularly useful if the number of opportunities for microparallelization could improve if the cost of the segments communicating with each other could be reduced by eliminating performance issues that many cached-based embodiments might introduce.

This embodiment therefore replaces the shared cache of FIG. 2 with a simpler and potentially faster scheme. Physically “adjacent” execution units are given a pair of shared registers. In the PowerPC architecture, these would be special purpose registers (SPRs). Other architectures could define similar registers in a manner consistent with their architecture's strategies for adding registers. Adjacent would be defined by the embodiment itself—this would probably be chosen based on some form of physical adjacency, but the limits of this are embodiment defined. The adjacency would be defined to maximize the ability for code to execute short sequences in parallel. That is, the shorter these various register propagations turn out to be, the smaller the profitable sequence available for parallelization. This is already a factor in some embodiments. For instance, in a what Intel calls hyperthreaded or even simply a classical symmetric multiple hardware processor embodiment, “adjacency” would tend to mean those that can share or at least have more efficient access to each other's resources, possibly including L1 cache, L2 cache or other such resources. It also means (as will shortly be seen) they have efficient access to at least one SPR register of the other execution unit in the pair. In today's processors, that will tend to mean reasonably close physicality so as to maximize the profit by minimizing the delay to read these registers in the “other” processor.

As just noted with the mention of Intel hyperthreads, these do not necessarily need to be complete hardware states. An industry practice known as “hyperthreading” (Intel) or “hardware multi-tasking” or “hardware multi-threading” (PowerPC as implemented by AS/400) already has two processors with a slightly abbreviated state sharing some resources (indeed, they might not even be termed “processors” in the literature because they lack a full state, but this is mostly a matter of definitional choice). These sorts of execution entities are typically “adjacent” in the sense described above.

All of these various embodiments will be called hardware threads. They may be more than that, but they must at least be that. “Hardware threads” differ from the “threads” previously described.

In any case, define two SPRs per paired hardware thread (per paired execution unit).

The first register is called the Local Register (LCR). This is a potentially “write only” register that allows “this” hardware thread to report its status to the “other” hardware thread. It is as wide as an instruction address.

The second register is called the Remote Register (RMR). This is a potentially “read only” register that allows “this” hardware thread to receive the status of the “other” hardware thread. It is as wide as an instruction address.

Moreover, they are interconnected such that the LCR of the first of a pair of adjacent hardware threads is the RMR of the other hardware thread of the pair and the second hardware thread's LCR is the RMR of the first hardware thread of the same pair.

The presumption is that a typical embodiment would be able to read or write these registers in a time equivalent to other typical operations. For instance, PowerPC defines a Link Register which is used for branching to a computed address. The LCR and RMR could advantageously be implemented with similar access costs. There certainly is an existing incentive to keep access costs to a link register low, though they might not be quite as efficient as access to GPRs (general purpose registers). Therefore, efficient access to LCR and RMR, with costs comparable to link registers would typically reduce the number of required parallel instructions for a profit. In other words, the useful size of the “micro” sequence to be parallelized will typically be shorter if a given embodiment achieves lower cost LCR and RMR access compared to the cache access costs of many cache-based embodiments.

Note also that in other embodiments, the LCR and RMR might become arrays so that instead of a single pair, as so far described, as many as four execution units might participate in the embodiment. See FIG. 4 for a way a set of four such hardware threads can connect to each other. For the case of two such hardware threads, only the first LCR and RMR need be implemented.

For added performance, in some embodiments, there would be the addition of another pair of registers. The Local Data Register (LDR) and RDR (remote data register). These would function in a manner similar to the LCR and RMR. Their purpose would be cache management. Because a given execution unit using the dependent binary would not necessarily know what the next executable would be, it would be useful to communicate to it a current indication of a shared stack. Thus, just before a new dependent segment would be invoked, the first segment writing to the LDR would expedite the start up of each dependent segment. Thus, being able to quickly pass the “base” address of the stack could be useful in a given embodiment as it would avoid the overhead of shared cache lines to communicate the current stack location (which, if the LCR/RMR pair made sense, it is likely the LDR/RDR also makes sense).

Also of interest is that in the shared cache schemes, since all the first and all the dependent segments contemplate sharing cache line(s), the LDR concept could be implemented within that shared space as an ordinary known memory location and simply loaded by the dependent segment after it determined it had a valid new instruction address. Since it just fetched the static cache line into its L1 (shared or not), that access to the memory-based LDR should be efficient in virtually any embodiment.

An Example

A brief example of parallelizable code of the sort envisioned in these embodiments follows.

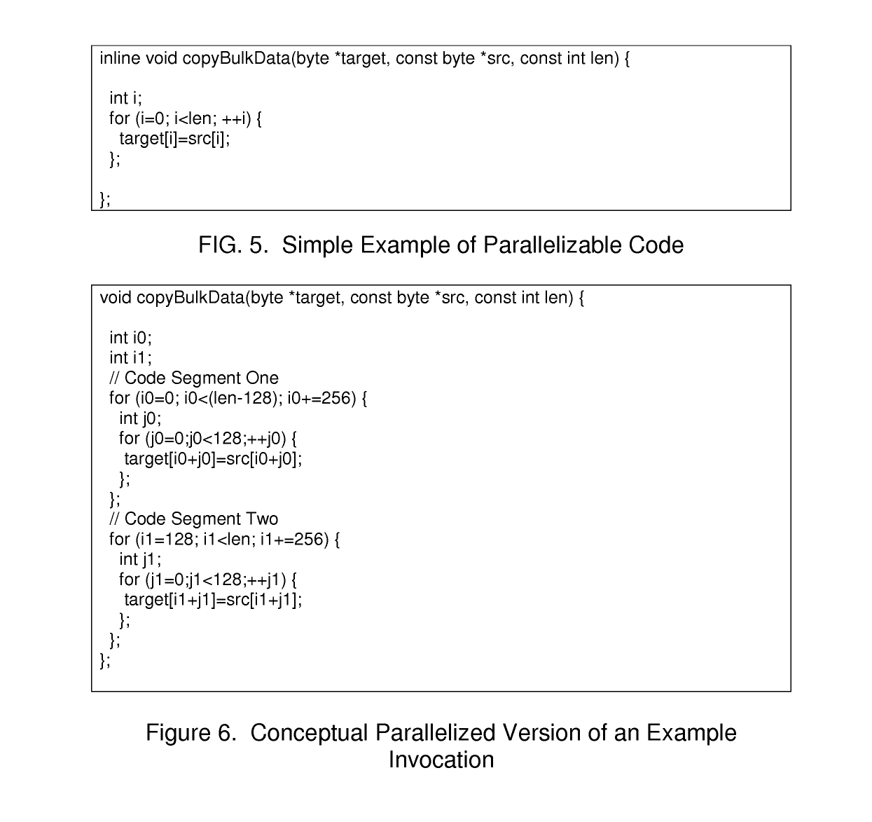

Suppose one has FIG. 5 as input source code in C/C++.

Here “byte” would typically be declared to some underlying primitive (usually char) such that a single byte of computer memory was specified. Note that the “inline” keyword means the compiler can, if it chooses, make a local copy of the code instead of a standard subroutine call to a single instance. Such code, especially in C++, is nowadays quite common. In effect, the code above can be called or, if it is somehow profitable, be treated more or less like a macro and subjected (in any given invocation) to any useful optimization.

Now, as a matter of formality, the programmer would expect that the result of FIG. 5's code is that the data is copied, one byte at a time, from the source storage to the target storage.

Further, if there were some problem (e.g. the target storage did not exist) that some suitable exception would take place at the smallest value of i for which the error was possible, because one expects the value of i (and the address of target) to start from the smallest value and increment to the largest.

Consider this Specific Invocation:

copyBulkData(targetLocation,sourceLocation,8192);

Assume that this invocation of code would in-lined. It would thus become a particular code group in the program.

Now further assume that the compiler knows (as it often can; perhaps it allocated sourceLocation and targetLocation) that targetLocation and sourceLocation are both on 128 byte boundaries, that they don't overlap in memory, and it of course can notice that 8192 is an even multiple of 128. The 128 is significant because the compiler could also know that cache lines on the machine of interest are 128 bytes in size. And, of course, the compiler knows what a “byte” is.

Given all that, the compiler could effectively rewrite the original code segment to look like FIG. 6. (FIG. 6 would not actually appear as C++ code, but it is a convenient representation of what the compiler might choose to do).

What we have, then, is the original code group divided into two segments. One segment that commences at the original “offset 0” of both source and target data and another segment that commences 128 bytes into the source and target. Further, each segment copies 128 bytes at a time until the specified length is exhausted. Further, each segment copies disjoint cache lines of the source and target such that the entire array is copied (as originally specified) but each commences on its own cache line and each copies alternate cache lines (note the increment of i0 and i1 by 256, the length of two cache lines) until the input is exhausted (as specified by len).

Compilers, using methods such as loop unrolling, which the above strongly resembles, have been motivated to do these sorts of optimizations before. Here, it would do so whenever it was convinced the profit from generating the extra code was profitable. In a compiler supporting the embodiments of the invention, that would basically mean that the segment of code containing i0 and j0 could be performed by one execution unit and the segment of code containing i1 and j1 could be performed by another execution unit. That means, of course, the code parallel one and code segment two do, in fact, execute in parallel. However, as they would be independent, asynchronous units, this requires some cooperation between the execution units. So, the above code is conceptual only. It would need further change to be actually executed in parallel.

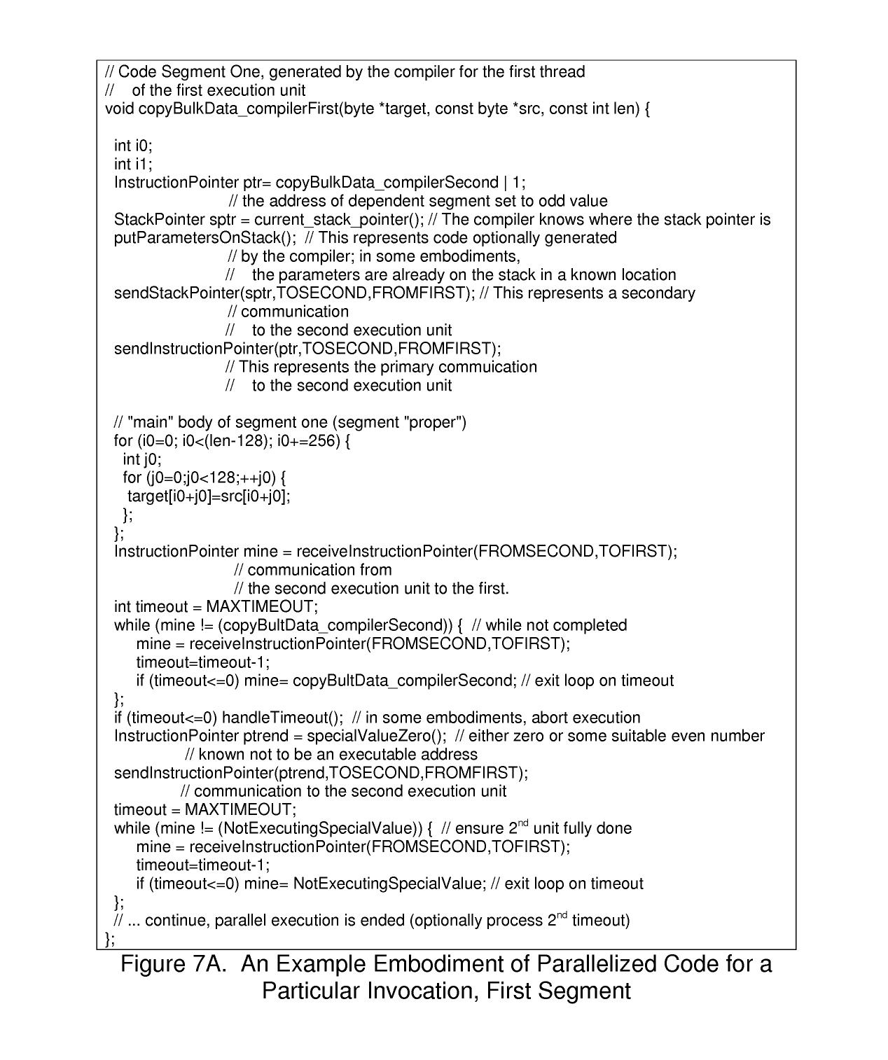

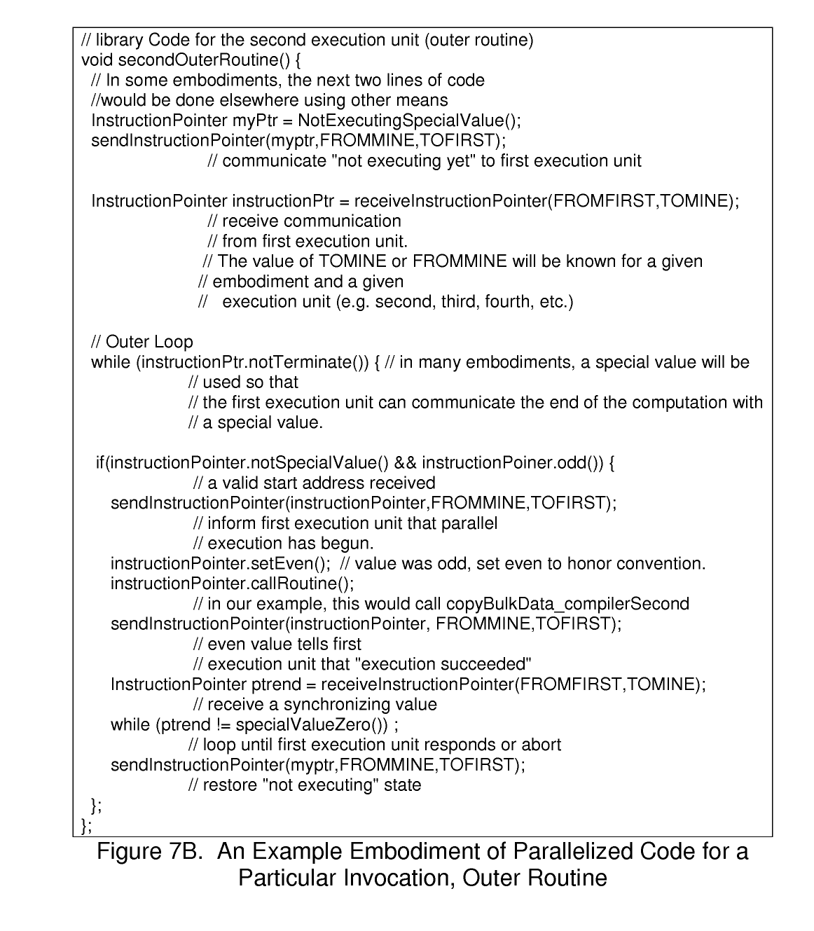

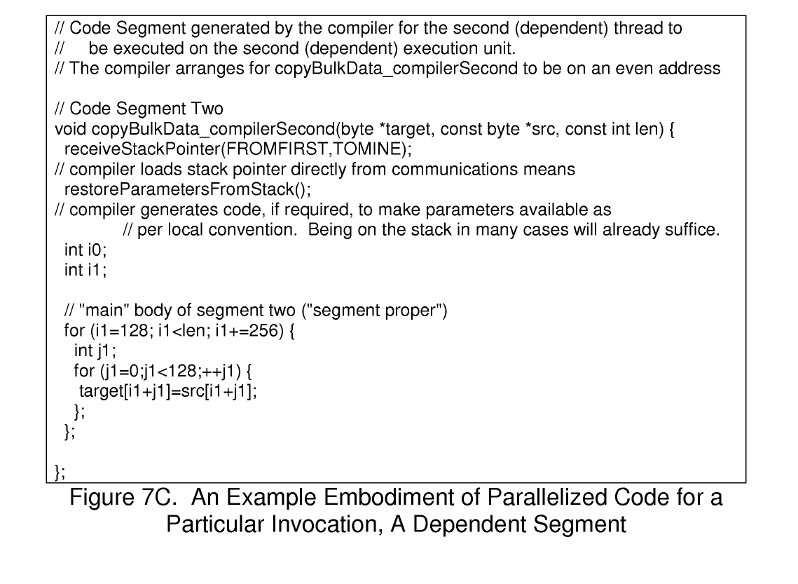

One embodiment of parallel execution is illustrated in FIGS. 7A-7C.

In FIGS. 7A-7C, we have a combination of true C/C++ code plus some special routines that indicate functions the compiler would generate. Here again, the code would not appear as C++ source, but it is a convenient representation of what the compiler would produce. In fact, putParametersOnStack and restoreParametersFromStack represent straightforward compiler items that are not visible in C++ source code, but manipulated “under the covers” by the compiler; since they share the stack register at the important times in execution, the compiler can store the parameters in the first code segment and then each dependent code segment can restore them in their dependent thread. In some embodiments, these functions would not even be required; the parameters are already on the stack at known offsets.

Similarly, sendInstructionPointer or receiveInstructionPointer will vary by the embodiment, but will represent the described function of sending or receiving the current value of the cache line or register as the particular embodiment describes. Functions of the instruction pointer (such as odd( ) NotExecutionSpecialValue( ), NotTerminate( )) are intended to show things described earlier, such as defining a convention that compiler created routines such as copyBulkData_compilerSecond will be arranged by convention to never commence on an odd address. This allows an odd instruction pointer value to signal commencing execution and an even one to indicate completion. The actual routine address (in even or odd form) then indicates which one. There would also be ample opportunity for special values as many “addresses” could be reserved so as to never be a valid segment address. In many embodiments, address values below a constant such as 4096 or 8192 would be disallowed because such addresses have other known uses in a given hardware embodiment and well known to the compiler. Exploiting this, two such special values would include “specialTimeoutValue( )” and “NotExecuting( )”, the latter of which means “I am not executing in parallel right now” and the first means “timeout occurred.” A third value could be zero, useful in a variety of contexts. Alternatively, as shown in FIG. 7A, a simple failure to obtain the completed value could, after a certain number of attempts, signal timeout in lieu of a special value.

Likewise, sendStackPointer and receivePointer also vary by the embodiment, but represent the functions of writing to or reading from the corresponding cache lines or registers. As the stack pointer is controlled by the compiler, it can put the result of a receiveStackRegister directly into the stack register.

Note that such optimization is not restricted to static source code compilation of the C or C++ kind. In Java, which tends to feature “just in time optimization” (that is, optimizations which occur on a binary representation of the original source at run time), it may be possible to recreate the conditions above at particular invocations at run time. In such a case, it could safely perform the substitution of code fragment above where it worked and perform the ordinary, sequential code when it did not. Even better, it could account for the specific processor and memory configuration in ways that might not work quite as well in static compilation. For instance, “just in time” notions could deal with architectures that vary the cache line size because it would know the value for the current machine at run time.

Those skilled in the art will appreciate how easy it would be to multiply the above example. For instance, a clearBulkData that set all values of the target to zero or some other fixed value. Only slightly more elaborately, it might be possible to deal with arrays of irregular objects. It is all a matter of profit and loss in the end.

Those skilled in the art will also appreciate that if there was enough profit, a third or fourth execution unit could be involved (by further “loop unrollings” similar to the above) and the third and fourth units would also wait in the dependent code's outer loop to receive notification from the first thread of the first execution unit.

Moreover, the programmer might choose to conspire with compiler writers and relax certain language rules (with suitable compiler options).

The above code has simplified error considerations because everything in the optimized case is easy; there is no real consideration of interrupts, for instance, because the compiler knows where everything is and if it will fail at all, it will fail at once (and it can arrange to check for that easily enough in only slightly more elaborate code than shown). Thus, failure could be made to look like the original code.

In more general cases, making failure look like the original code might not be so easy to manage. However, there are already compiler options in the world that can shut off strict requirements as far as strict adherence to the language rules are concerned. New such options might be defined (e.g. “relax strict sequential execution”) such that code would have to contend with code fragments above having the same basic problem first manifest itself at different array offsets than a strictly sequential implementation would give. Particularly, the code may fail in the segment incrementing “i1” before the corresponding array processing has happened in the “i0”. But, the original source only knows of “i” and (if a fully sequential definition was expected) would expect all smaller values of “i” to have been processed. If “i1” fails first, this has not happened. What follows from that point would be embodiment dependent and possibly situation dependent, but the programmer might be willing to accept an out-of-order failure result to get the profit. Despite what was just said, error handling code is often very broad; it would as often or not only handle out-of-order failure, it would often handle failures both before and after the parallelized code to start with, all identically. That is, much existing error code might not care about strict sequential execution in a given case being insensitive to where in a relatively large unit of code failure happened. Particularly, it would not care about the value of “i” nor about how much data and where data was copied. One way this could arise is that it might retry the function it covers or simply discard the work and do something else (e.g. terminate the program). Either would tend to make details of the point of failure irrelevant.

The compiler could also have a more daring code generation than assumed in FIGS. 7A-7C. The compiler could have any number of assumptions about the execution environment.

Of particular interest would be hardware interrupts. A timeout value would have to account for time lost servicing hardware interrupts. The simplest scheme would be to arrange for the operating system (in a cooperative scheme with the compiler) to suspend all execution units on a hardware exception in any individual execution unit in the set. This would allow the compiler to make more aggressive assumptions about synchronization (and timeout) than might otherwise be the case. Such cooperation is more plausible than it might first appear.

Consider Common Interrupts:

1. Page fault interrupts. Here, a virtual storage address is not available. If one looks at the FIGS. 7A-7C example, it will be apparent that if the segments in the various threads are at all synchronized, a page fault to one will very quickly be a page fault in the others. Indeed, the operating system must cope (as it already does in conventional threading) with the possibility that all the execution units will page fault before it can even commence processing on whichever execution unit has the page fault first. Ceasing those that have not faulted (when known to be part of a set of execution units implementing this disclosure) would be a comparatively minor matter.

2. Time slice end. Here again, if the time slice is exceeded, it would make sense for the operating system to process all execution units in the set as they all should be having the exception nearly at once.

3. I/O or other external events. Here, some asynchronous event more important than the current code has arisen. It would again make sense to suspend all execution units if one unit is to be suspended. The time between very early interrupt processing and the ability of the operating system to suspend the other execution units would be a factor in deciding on a timeout value. However, if the code involved in the segments is sufficiently short, an arbitrary number of these items need not be assumed in a functional system.

4. Severe errors (such as division by zero). In many embodiments, things like dividing by zero cause machine interrupts. Many of these end up terminating execution, because recovery is uncertain and difficult. In other cases, the resumption is so crude, the operating system can simply cease the current parallel execution and arrange things to resume in a manner closely resembling the initial program state. That is to say, it would resume at a specified code group in the first execution unit in some sort of error handler that would be a group “not profitable for parallel execution” and would have reset the dependent execution units to resume in the outer loop awaiting a new segment address.

Beyond interrupts, there is another consideration. In the register-based embodiment disclosed, there may be an added problem. The initial value of the registers may need to be dealt with. This can be done in any number of ways. Particularly, a separate set of library code can be invoked by the compiler (or, even, by the programmer aware of this possible optimization in cooperation with the compiler) such that conventional cache sharing was performed between the first execution unit (which always gets initial control, assigned to its associated thread) and the dependent execution units (assigned to their associated dependent threads), using the conventional cache thread communication schemes to communicate desired initial values from the first execution unit to the remaining execution units prior to any parallel code being attempted. Since each execution unit is associated with a particular thread, this is easily arranged. The simplest scheme sets these values in a known location before the dependent execution units begin executing; they simply fetch these and write them to any registers necessary. Communication of success back to the first execution unit can be via cache.

Finally, nothing prevents the compiler from being very aggressive about its assumptions, if it is willing enough to risk some sort of aborted execution. It may be enough for it to simply communicate the two even and odd values of the instruction pointer back and forth, relying on sufficient synchronization to prevent the execution units from getting out of synch. In real time environments, where interrupts may be forbidden for periods of time, such an assumption may be valid. It might also be possible to do this in situations where two profitable code segments are close enough together as to make some of the communication shown in FIGS. 7A-7C unnecessary.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims. Moreover, the terms “first,” “second,” and “third,” etc., are used merely as labels, and are not intended to impose numerical requirements on their objects.

I claim:

1. A computer implemented method comprising:
I. at compile time,
a. configuring a specified plurality of threads,
b. identifying a plurality of code segments within a program for parallel execution,
c. configuring each of said code segments into is own said thread,
d. configuring each of said threads to execute on a separate execution unit,
e. dividing said threads into a first thread and at least one dependent thread,
f. configuring said at least one dependent thread to perform thread communications using communications means to communicate with said first thread for the purpose of coordinating parallel execution,
g. configuring said first thread to perform thread communications using communication means to communicate with said at least one dependent thread for the purpose of coordinating parallel execution,
h. generating an executable program comprising said code segments and code for thread communications,
II. at execution time,
i. loading said executable program into memory, associating said executable program with a plurality of execution units, associating each said execution unit with a particular thread, and
j. executing said executable program.

2. The method of claim 1 where any communications means comprises cache lines.

3. The method of claim 1 where any communications means comprises cache lines shared between execution units.

4. The method of claim 1 where any communications means comprises registers.

5. The method of claim 1 where each said code segment for said dependent threads are organized into an outer routine containing an outer loop such that the outer loop is configured to invoke a particular said code segment corresponding to said dependent thread.

6. The method of claim 1 where the generated code for said dependent threads includes library code.

7. The method of claim 1 wherein said executable program exactly produces the same results as had said executable program been conventionally compiled.

8. The method of claim 1 wherein said thread communications also includes communicating a second value.

9. A computer-readable medium having instructions stored thereon for causing a suitably programmed information processor to execute a method that comprises:
I. At compile time,
a. configuring a specified plurality of threads,
b. identifying a plurality of code segments within a program for parallel execution,
c. configuring each of said code segments into is own said thread,
d. configuring each of said threads to execute on a separate execution unit,
e. dividing said threads into a first thread and at least one dependent thread,
f. configuring said at least one dependent thread to perform thread communications using communications means to communicate with said first thread for the purpose of coordinating parallel execution,
g. configuring said first thread to perform thread communications using communication means to communicate with said at least one dependent thread for the purpose of coordinating parallel execution,
h. generating an executable program comprising said code segments and code for thread communications,
II. at execution time,
i. loading said executable program into memory, associating said executable program with a plurality of execution units, associating each said execution unit with a particular thread, and
j. executing said executable program.

10. The medium of claim 9 further comprising instructions to cause the method to use communications means comprising cache lines.

11. The medium of claim 9 further comprising instructions to cause the method to use communication means comprising cache lines shared between execution units.

12. The medium of claim 9 further comprising instructions to cause the method to use communication means comprising registers.

13. The medium of claim 9 further comprising instructions to cause the method to generate for each said code segment for said dependent threads such that said code segments for the dependent thread are organized into an outer routine containing an outer loop such that the outer loop is configured to invoke a particular said code segment corresponding to said dependent thread.

14. The medium of claim 9 where the generated code for said dependent threads includes library code.

15. The medium of claim 9 further comprising instructions to cause the method to produce a resulting program that exactly produces the same results as had the program been conventionally compiled.

16. The medium of claim 9 further comprising instructions to cause the method to communicate a second value.

17. An apparatus comprising a computer system with a plurality of execution units, each with communication means to communicate with each other execution unit, the computer system further containing memory operatively connected to the execution units and further including computer-readable media, operatively connected to the computer memory wherein said apparatus
I. receives and stores a computer program into its computer-readable media, said computer program produced by a compilation method which;
a. configures a specified plurality of threads,
b. identifies a plurality of code segments within a program for parallel execution,
c. configures each of said code segments into is own said thread,
d. configures each of said threads to execute on a separate execution unit,
e. divides said threads into a first thread and at least one dependent thread,
f. configures said at least one dependent thread to perform thread communications using communications means to communicate with said first thread for the purpose of coordinating parallel execution,
g. configures said first thread to perform thread communications using communication means to communicate with said at least one dependent thread for the purpose of coordinating parallel execution,
h. generates an executable program comprising said code segments and code for thread communications, and
II. wherein said apparatus, having received and stored said computer program loads said executable program into memory;
j. creates a particular thread, as configured by said computer program, associating each said execution unit with a particular thread, including a first thread and at least one dependent thread, each commencing execution at a specified initial location in said memory, and
j. executes said executable program on said computer system.

18. The apparatus of claim 17 where any communication means further comprises cache lines shared between execution units.

19. The method of claim 17 where any communications means comprises registers.

20. The method of claim 17 where the receiving of the program is selected from a group consisting of:
i) a CD-ROM drive containing a CD-ROM media operatively connected to said computer system,
ii) a tape drive containing a tape media operatively connected to said computer system, and
iii) a magnetic disk operatively connected to said computer system.
